(19) United States
(12) Patent Application Publication
(10) Pub. No.: US 2014/0260715 A1
(43) Pub. Date: Sep. 18, 2014

(54) LINEAR/ROTARY MOTION TRANSFORMING DEVICE

(71) Applicant: RAYTHEON COMPANY, Waltham, MA (US)

(72) Inventors: Fraser M. Smith, Waltham, MA (US); Shane Olsen, Waltham, MA (US); Glenn Colvin, JR., Waltham, MA (US); Brian Maclean, Waltham, MA (US); Michael Morrison, Waltham, MA (US)

(73) Assignee: Raytheon Company, Waltham, MA (US)

(21) Appl. No.: 13/800,582

(22) Filed: Mar. 13, 2013

(51) Int. Cl. F16H 19/02

(52) U.S. Cl. CPC F16H 19/02
USPC 74/25

(57) ABSTRACT

A linear/rotary motion transforming device is disclosed. The device includes a first member, a second member, and a third member disposed along an axis such that the second member is disposed between the first member and the third member. The second member is linearly movable along the axis and rotatable about the axis. The third member is rotatable about the axis. Connecting elements pivotally couple the first member and the second member, and the second member and the third member, offset from the axis. The first member and the second member are linearly and rotatably movable relative to one another, and the second member and the third member are linearly and rotatably movable relative to one another. A load input mechanism is operably coupled to the second member or the third member. Load output is transferred via the other of the second member or the third member.

### BACKGROUND

Robotic devices typically utilize rotary and linear actuators to actuate and control movement of joints having rotational degrees of freedom. Hydraulic actuators, and particularly hydraulic linear actuators, are generally favorable for applications requiring high torque. Some robots are anthropomorphic to represent or mimic, for example, a human arm or leg. Human arms and legs have rotational degrees of freedom, such as humeral rotation, wrist rotation, thigh rotation, and calf rotation.

### BRIEF DESCRIPTION OF THE DRAWINGS

Features and advantages of the invention will be apparent from the detailed description which follows, taken in conjunction with the accompanying drawings, which together illustrate, by way of example, features of the invention; and, wherein:

FIG. 1 is an example illustration of a linear/rotary motion transforming device in accordance with an embodiment of the present invention.

FIG. 2 is a schematic illustration of the linear/rotary motion transforming device of FIG. 1.

FIGS. 3A-3C illustrate operation of the linear/rotary motion transforming device of FIG. 1.

FIG. 4 is an example illustration of a linear/rotary motion transforming device in accordance with another embodiment of the present invention.

FIG. 5 is a schematic illustration of the linear/rotary motion transforming device of FIG. 1.

FIGS. 6A-6C illustrate operation of the linear/rotary motion transforming device of FIG. 1.

FIG. 7 is an example illustration of a linear/rotary motion transforming device in accordance with yet another embodiment of the present invention.

FIG. 8 is a schematic illustration of the linear/rotary motion transforming device of FIG. 1.

FIGS. 9A-9C illustrate operation of the linear/rotary motion transforming device of FIG. 1.

Reference will now be made to the exemplary embodiments illustrated, and specific language will be used herein to describe the same. It will nevertheless be understood that no limitation of the scope of the invention is thereby intended.

### DETAILED DESCRIPTION

As used herein, the term “substantially” refers to the complete or nearly complete extent or degree of an action, characteristic, property, state, structure, item, or result. For example, an object that is “substantially” enclosed would mean that the object is either completely enclosed or nearly completely enclosed. The exact allowable degree of deviation from absolute completeness may in some cases depend on the specific context. However, generally speaking the nearness of completion will be so as to have the same overall result as if absolute and total completion were obtained. The use of “substantially” is equally applicable when used in a negative connotation to refer to the complete or near complete lack of an action, characteristic, property, state, structure, item, or result.

As used herein, “adjacent” refers to the proximity of two structures or elements. Particularly, elements that are identified as being “adjacent” may be either abutting or connected. Such elements may also be near or close to each other without necessarily contacting each other. The exact degree of proximity may in some cases depend on the specific context.

An initial overview of technology embodiments is provided below and then specific technology embodiments are described in further detail later. This initial summary is intended to aid readers in understanding the technology more quickly but is not intended to identify key features or essential features of the technology nor is it intended to limit the scope of the claimed subject matter.

Although typical linear actuators have many benefits, for anthropomorphic robot applications, linear actuators can be problematic in achieving an anthropomorphic form factor and a high range of motion. For example, in such applications, the desired range of motion can be greater than 70 degrees. For instance, about 180 degrees is needed to approximate wrist or humeral rotation. Such ranges of motion can be difficult to achieve using a linear actuator in a form factor representing a human arm or leg.

Accordingly, a linear/rotary motion transforming device is disclosed that can provide the range of angular motion typical of anthropomorphic robot applications in a package that can fit within an anthropomorphic form factor. The linear/rotary motion transforming device can include a first member disposed along an axis. The device can also include a second member linearly movable along the axis and rotatable about the axis. A first connecting element can be pivotally coupled to the first member and the second member, and offset from the axis. The first member and the second member can be linearly and rotatably movable relative to one another. The device can further include a third member rotatable about the axis. The second member can be disposed along the axis between the first member and the third member. A second connecting element can be pivotally coupled to the second member and the third member, and offset from the axis. The second member and the third member can be linearly and rotatably movable relative to one another. In addition, the device can include a load input mechanism operably coupled to the second member or the third member. Load output can be transferred via the other of the second member or the third member.

In another aspect, a linear/rotary motion transforming device can include a first member disposed along an axis. The device can also include a second member linearly movable along the axis and rotatable about the axis. A first connecting element can be pivotally coupled to the first member and the second member, and offset from the axis. The first member and the second member can be linearly and rotatably movable relative to one another. The device can further include a third member rotatable about the axis. A second connecting element can be pivotally coupled to the second member and the third member, and offset from the axis. The second member and the third member can be linearly and rotatably movable relative to one another. Furthermore, the device can include a fourth member linearly movable along the axis and rotatable about the axis. A third connecting element can be pivotally coupled to the third member and the fourth member, and offset from the axis. The third member and the fourth member can be linearly and rotatably movable relative to one another.

One embodiment of a linear/rotary motion transforming device 100 is illustrated in FIGS. 1 and 2. FIG. 1 illustrates a perspective view and FIG. 2 illustrates a schematic representation of the linear/rotary motion transforming device 100. The linear/rotary motion transforming device 100 can comprise a first member 110 disposed along an axis 101. A second member 120 can be movable bi-directionally in a linear direction 102 along the axis 101 and can also be rotatable bi-directionally in a direction 103 about the axis 101. A first connecting element 141a can be pivotally coupled to the first member 110 and the second member 120 to provide three rotational degrees of freedom, such as via universal pivots 140, and offset a distance 104 from the axis 101. The first member 110 and the second member 120 can therefore be linearly and rotatably movable relative to one another and coupled via the first connecting element 141a.

The linear/rotary motion transforming device 100 can also include a third member 130 that can also be rotatable bi-directionally in a direction 105 about the axis 101. As shown in the figures, the second member 120 can be disposed along the axis 101 between the first member 110 and the third member 130. A second connecting element 142a can be pivotally coupled to the second member 120 and the third member 130, such as via universal pivots 140, and offset 106 from the axis 101. The first member 110 and the third member 130 can be disposed at a fixed distance 107 from one another, and the second member 120 can translate between them. The fixed distance 107 can be maintained by housing 160. The second member 120 and the third member 130 can therefore be linearly and rotatably movable relative to one another and coupled via the second connecting element 142a. For example, as shown in the figure, the third member 130 can be fixed linearly by the housing 160 such that the second member 120 moves linearly within the housing while rotating relative to one another. In one aspect, a length 108 of the first connecting element 141a and a length 109 of the second connecting element 142a can be the same or different from one another.

In one aspect, the housing 160 can be configured to fit within an anthropomorphic form factor. Although a cylindrical housing is illustrated, any suitable housing shape can be utilized. In another aspect, the housing 160 can be configured to support structural loads, and can therefore form a structural part of a robot, such as an anthropomorphic limb. One benefit of the housing is that pinch points created by the moving members and connecting elements can be enclosed within the housing 160. In addition, moving parts can be lubricated within an oil bath within the housing 160.

It should be recognized that any number of additional connecting elements can be incorporated to couple the first member 110 and the second member 120 (illustrated by additional connecting element 141b) and/or the second member 120 and the third member 130 (illustrated by additional connecting element 142b). It should be further recognized that a universal pivot 140 can comprise various devices or systems capable of providing at least three rotational degrees of freedom, such as, a ball joint, a universal joint associated with a rotational member, or the like. Varying the connecting element lengths 108, 109 and offsets 103, 104 can impact the rotational characteristics and range of rotational motion of the linear/rotary motion transforming device 100.

In addition, the linear/rotary motion transforming device 100 can include a load input mechanism. In one embodiment, a load input mechanism 150a can be operably coupled to the second member 120 such that load output 151a is transferred via the third member 130. For example, the load input mechanism 150a can be configured to provide force in the linear direction 102, such as by causing linear displacement of the second member 120. In one aspect, the load input mechanism 150a can comprise an actuator, such as a linear actuator or a rotary actuator. As shown in FIGS. 1 and 2, the load input mechanism 150a can be disposed in an outboard configuration proximate the first member 110. In one aspect, the load input mechanism 150a can comprise a piston 152 disposed in a cylinder 153 and operably coupled to the second member 120, such as by connecting shaft or rod 154. The load input mechanism can include a hydraulic, pneumatic, electric, mechanical, or any other load imparting mechanism. As used herein, a “load” can include a force and/or a moment or torque. In another embodiment, a load input mechanism 150b can be operably coupled to the third member 130 such that load output 151b is transferred via the second member 120. For example, the load input mechanism 150b can be disposed in an outboard configuration proximate the third member 130. In one aspect, the load output can resist and/or dissipate energy from the load input, such as by incorporating the piston 152 and cylinder 153 to function as a dampening mechanism.

It should be recognized that although an outer structure of the load input mechanism/load output 150a/151b is shown as being fixed in FIG. 2, any suitable component of the linear/rotary motion transforming device 100, such as the first member 110, the second member 120, or the third member 130, can be fixed or provide a fixed reference relative to another of the components. For example, the third member 130 can be fixed and the first member 110 can be configured to rotate about the axis 101. In one aspect, the linear/rotary motion transforming device 100 can be configured for maximum rotation. In another aspect, the linear/rotary motion transforming device 100 can be configured for maximum torque or a required torque output across the range of motion.

FIGS. 3A-3C illustrate the linear/rotary motion transforming device 100 in operation. For example, the piston 152 can be located at an end of the cylinder 153, as shown in FIG. 3A. The piston 152 can be coupled to the second member 120 and caused to move linearly in direction 102, as shown in FIG. 3B. The first member 110 can be fixed relative to the cylinder 153, and the connecting elements 141a, 141b can be coupled to the first member 110 and the second member 120. Thus, as the piston 152 acts on the second member 120 to move linearly in direction 102, the second member 120 can be caused to rotate in direction 103 by the connecting elements 141a, 141b coupled to the first member 110. Furthermore, the connecting elements 142a, 142b can be coupled to the second member 120 and the third member 130. The linear movement in direction 102 of the second member 120 relative to the third member 130 can therefore cause a certain amount of rotation of the third member 130. In addition, the rotation of the second member 120 in direction 103 can also impart rotation to the third member 130 in direction 105, resulting in a relative rotational difference between the second member 120 and the third member 130. All linear and rotational movement within the linear/rotary motion transforming device 100 can cease when the piston 152 reaches an end of travel at an opposite end of the cylinder 153, as shown in FIG. 3C. Movements in opposite directions can occur when the piston 152 is caused to move in a reverse direction. Thus, as shown and described herein, a linear load can be converted and transferred into a rotary load, and vice versa.

Another embodiment of a linear/rotary motion transforming device 200 is illustrated in FIGS. 4 and 5. FIG. 4 illustrates a perspective view and FIG. 5 illustrates a schematic representation of the linear/rotary motion transforming device 200. The linear/rotary motion transforming device 200 can comprise elements and components that function similar to those of the linear/rotary motion transforming device 100 discussed hereinabove, namely a first member 210, a second member 220, a third member 230, a first connecting element 241a, 241b pivotally coupled to the first member 210 and the second member 220, and a second connecting element 242a, 242b pivotally coupled to the second member 220 and the third member 230, and a load output/load input mechanism 251a/250b operably coupled to the third member 230. In this case, however, a load input mechanism/load output 250a/251b is disposed along the axis 201 between the first member 210 and the third member 230. For example, the load input mechanism/load output 250a/251b can be disposed in an inboard configuration integral with or within the second member 220. In one aspect, the load input mechanism/load output 250a/251b can comprise a piston 252 disposed in a cylinder 253 operably coupled to the second member 220. Here, the cylinder 253 can be fixed relative to the second member 220 and the piston 252 can translate in direction 202 and rotate in direction 203 relative to the second member 220. The first member 210 and the third member 230 can be disposed at a fixed distance 207 from one another, and the second member 220 can translate between them. The fixed distance can be maintained by a connecting shaft or rod 260.

It should be recognized that although the first member 210 is shown as being fixed in FIG. 5, any suitable component of the linear/rotary motion transforming device 200, such as the second member 220 or the third member 230, can be fixed or provide a fixed reference relative to another of the components. For example, the third member 230 can be fixed and the first member 210 can be configured to rotate about the axis 201.

FIGS. 6A-6C illustrate the linear/rotary motion transforming device 200 in operation. For example, in FIG. 6A, the piston 252 can be located at an end of the cylinder 253. The cylinder 253 can be fixed relative to the second member 220, and caused to move linearly in direction 202, as shown in FIG. 6B. The first member 210 can be fixed relative to the piston 252, and the connecting elements 241a, 241b can be coupled to the first member 210 and the second member 220. Thus, as the piston 252 acts within the cylinder 253 to move the second member 220 linearly in direction 202, the second member 220 can be caused to rotate in direction 203 by the connecting elements 241a, 241b coupled to the first member 210. Furthermore, the connecting elements 242a, 242b can be coupled to the second member 220 and the third member 230. The linear movement in direction 202 of the second member 220 relative to the third member 230 can therefore cause a certain amount of rotation of the third member 230. In addition, the rotation of the second member 220 in direction 203 can also impart rotation to the third member 230 in direction 205, resulting in a relative rotational difference between the second member 220 and the third member 230. All linear and rotational movement within the linear/rotary motion transforming device 200 can cease when the piston 252 reaches an end of travel at an opposite end of the cylinder 253, as shown in FIG. 6C. Movements in opposite directions can occur when the piston 252 is caused to move in a reverse direction within the cylinder 253.

Yet another embodiment of a linear/rotary motion transforming device 300 is illustrated in FIGS. 7 and 8. FIG. 7 illustrates a perspective view and FIG. 8 illustrates a schematic representation of the linear/rotary motion transforming device 300. The linear/rotary motion transforming device 300 can comprise a first member 310 disposed along an axis 301. A second member 320 can be movable bi-directionally in a linear direction 302 along the axis 301 and can also be rotatable bi-directionally in a direction 303 about the axis 301. A first connecting element 341a, 341b can be pivotally coupled to the first member 310 and the second member 320, such as via universal pivots 345, and offset 311 from the axis 301. The first member 310 and the second member 320 can therefore be linearly and rotatably movable relative to one another and coupled via the first connecting element 341a. The linear/rotary motion transforming device 300 can also include a third member 330 that can also be rotatable bi-directionally in a direction 305 about the axis 301. As shown in the figures, at least a portion of the third member 330 can be disposed radially outboard of the first member 310 and/or the second member 320. A second connecting element 342a, 342b can be pivotally coupled to the second member 320 and the third member 330, such as via universal pivots 345, and offset 321 from the axis 301. The second member 320 and the third member 330 can therefore be linearly and rotatably movable relative to one another and coupled via the second connecting element 342a.

The linear/rotary motion transforming device 300 can also include a fourth member 340 that can be movable bi-directionally in a linear direction 302 along the axis 301 and can also be rotatable bi-directionally in a direction 306 about the axis 301. A third connecting element 343a, 343b can be pivotally coupled to the third member 330 and the fourth member 340, such as via universal pivots 345, and offset 331 from the axis 301. The third member 330 and the fourth member 340 can therefore be linearly and rotatably movable relative to one another and coupled via the third connecting element 343a. In one aspect, the second member 320 and the fourth member 340 can be move linearly in concert with one another while rotating differently. In a particular aspect, the second member 320 and the fourth member 340 can be constrained to move linearly in concert with one another. A fifth member 350 can be rotatable bi-directionally in a direction 308 about the axis 301. A fourth connecting element 344a, 344b can be pivotally coupled to the fourth member 340 and the fifth member 350, such as via universal pivots 345, and offset 341 from the axis 301. The fourth member 340 and the fifth member 350 can therefore be linearly and rotatably movable relative to one another and coupled via the fourth connecting element 344a. As shown in the figures, at least a portion of the third member 330 can be disposed radially outboard of the fourth member 340 and/or the fifth member 350. In one aspect, the first member 310 and the fifth member 350 can be disposed at a fixed distance 307 from one another, and the second member 320 and the fourth member 340 can translate between them. The fixed distance 307 can be maintained by the third member 330, such as by a housing 336 of the third member 330. It should be recognized that although pairs of connecting elements are shown between coupled members, any suitable number of connecting elements may be used.

By “folding back” the connection between the second member 320 and the third member 330, the overall length of the device 300 can be reduced compared to the devices 100 and 200 discussed hereinabove, while achieving a high range of angular motion that can approach the ranges of motion possible by the devices 100 and 200. In addition, utilizing the third member 330 to couple with the fourth and fifth members 340, 350 can impart additional range of motion to the device.

In addition, the linear/rotary motion transforming device 300 can include a load input mechanism. In one embodiment, a load input mechanism 360a can be operably coupled to the second member 320 such that load output 361a is transferred via the fifth member 350. For example, the load input mechanism 360a can be configured to provide force in the linear direction 302, such as by causing linear displacement of the second member 320 as shown and described hereinabove with regard to linear/rotary motion transforming device 100 and 200. In another embodiment, a load input mechanism 360b can be operably coupled to the fifth member 350 such that load output 361b is transferred via the second member 320. In one aspect, the load output can resist and/or dissipate energy from the load input, such as by incorporating a dampening mechanism. It should be recognized that a load input mechanism can be operably coupled to the first member, the second member, the third member, the fourth member, or the fifth member, such that load output is transferred via one of the other of the members.

It should be further recognized that although the first member 310 is shown as being fixed in FIG. 8, any suitable component of the linear/rotary motion transforming device 300, such as the second member 320, the third member 330, the fourth member 340, or the fifth member 350, can be fixed or provide a fixed reference relative to another of the components. For example, the fifth member 350 can be fixed and the first member 310 can be configured to rotate about the axis 301. In another example, the third member 330 can be fixed and a rotational load input can be applied to the first member 310 to cause a rotational load output at the fifth member 350. The different relative rotations from the input and the output can therefore provide a “gear ratio” between the rotational input and output.

FIGS. 9A-9C illustrate the linear/rotary motion transforming device 300 in operation. For example, in FIG. 9A, the second member 320 and the fourth member 340 can be located toward the first member 310 and away from the fifth member 350, which are separated by the third member 330. The second member 320 can be caused to move linearly in direction 302, as shown in FIG. 9B. The first member 310 can be fixed, and the connecting elements 341a, 341b can be coupled to the first member 310 and the second member 320. Thus, as the second member 320 moves linearly in direction 302, the second member 320 can be caused to rotate in direction 303 by the connecting elements 341a, 341b coupled to the first member 310. Furthermore, the connecting elements 342a, 342b can be coupled to the second member 320 and the third member 330. The linear movement in direction 302 of the second member 320 relative to the third member 330 can therefore cause rotation of the third member 330. In addition, the rotation of the second member 320 in direction 303 can also impart rotation to the third member 330 in direction 305, resulting in a relative rotational difference between the second member 320 and the third member 330. Moreover, the connecting elements 343a, 343b can be coupled to the third member 330 and the fourth member 340. Thus, as the third member 320 rotates, the fourth member 340 can be caused to rotate in direction 306 by the connecting elements 343a, 343b coupled to the third member 330. The connecting elements 344a, 344b can be coupled to the fourth member 340 and the fifth member 350. The linear movement in direction 302 of the fourth member 340 relative to the fifth member 350 can therefore cause rotation of the fifth member 350. In addition, the rotation of the fourth member 340 in direction 306 can also impart rotation to the fifth member 350 in direction 308, resulting in a relative rotational difference between the fourth member 340 and the fifth member 350. All linear and rotational movement within the linear/rotary motion transforming device 300 can cease when the second member 320 and/or the fourth member 340 reaches an end of travel, as shown in FIG. 9C. Movements in opposite directions can occur when the second member 320 and/or the fourth member 340 is caused to move in a reverse direction.

In accordance with one embodiment of the present invention, a method for facilitating transforming of linear/rotary motion is disclosed. The method can comprise providing a linear/rotary motion transforming device, having a first member disposed along an axis, a second member linearly movable along the axis and rotatable about the axis, a first connecting element pivotally coupled to the first member and the second member, and offset from the axis, wherein the first member and the second member are linearly and rotatably movable relative to one another, a third member rotatable about the axis, wherein the second member is disposed along the axis between the first member and the third member, and a second connecting element pivotally coupled to the second member and the third member, and offset from the axis, wherein the second member and the third member are linearly and rotatably movable relative to one another. Additionally, the method can comprise facilitating coupling of a load input mechanism to the second member or the third member, wherein load output is transferred via the other of the second member or the third member. In one aspect, the load input mechanism can be disposed proximate the first member or the third member, along the axis between the first member and the third member, or within the second member. It is noted that no specific order is required in this method, though generally in one embodiment, these method steps can be carried out sequentially.

It is to be understood that the embodiments of the invention disclosed are not limited to the particular structures, process steps, or materials disclosed herein, but are extended to equivalents thereof as would be recognized by those ordinarily skilled in the relevant arts. It should also be understood that terminology employed herein is used for the purpose of describing particular embodiments only and is not intended to be limiting.

Reference throughout this specification to “one embodiment” or “an embodiment” means that a particular feature, structure, or characteristic described in connection with the embodiment is included in at least one embodiment of the present invention. Thus, appearances of the phrases “in one embodiment” or “in an embodiment” in various places throughout this specification are not necessarily all referring to the same embodiment.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary. In addition, various embodiments and example of the present invention may be referred to herein along with alternatives for the various components thereof. It is understood that such embodiments, examples, and alternatives are not to be construed as de facto equivalents of one another, but are to be considered as separate and autonomous representations of the present invention.

Furthermore, the described features, structures, or characteristics may be combined in any suitable manner in one or more embodiments. In the description, numerous specific details are provided, such as examples of lengths, widths, shapes, etc., to provide a thorough understanding of embodiments of the invention. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention.

While the foregoing examples are illustrative of the principles of the present invention in one or more particular applications, it will be apparent to those of ordinary skill in the art that numerous modifications in form, usage and details of implementation can be made without the exercise of inventive faculty, and without departing from the principles and concepts of the invention. Accordingly, it is not intended that the invention be limited, except as by the claims set forth below.

What is claimed is:

1. A linear/rotary motion transforming device, comprising:
a first member disposed along an axis;
a second member linearly movable along the axis and rotatable about the axis;
a first connecting element pivotally coupled to the first member and the second member, and offset from the axis, wherein the first member and the second member are linearly and rotatably movable relative to one another;
a third member rotatable about the axis, wherein the second member is disposed along the axis between the first member and the third member;
a second connecting element pivotally coupled to the second member and the third member, and offset from the axis, wherein the second member and the third member are linearly and rotatably movable relative to one another; and
a load input mechanism operably coupled to the second member or the third member, wherein load output is transferred via the other of the second member or the third member.

2. The linear/rotary motion transforming device of claim 1, wherein the load input mechanism comprises an actuator.

3. The linear/rotary motion transforming device of claim 2, wherein the actuator comprises a linear actuator or a rotary actuator.

4. The linear/rotary motion transforming device of claim 1, wherein the load input mechanism is disposed proximate the first member or the third member.

5. The linear/rotary motion transforming device of claim 1, wherein the load input mechanism is disposed along the axis between the first member and the third member.

6. The linear/rotary motion transforming device of claim 1, wherein the load input mechanism is disposed within the second member.

7. The linear/rotary motion transforming device of claim 1, wherein the load input mechanism comprises a piston operably coupled to the second member.

8. The linear/rotary motion transforming device of claim 1, further comprising a piston operably coupled to the second member to resist the load output.

9. The linear/rotary motion transforming device of claim 1, wherein the first member and the third member are disposed at a fixed distance from one another and the second member translates between them.

10. The linear/rotary motion transforming device of claim 9, wherein the fixed distance is maintained by at least one of a housing and a rod.

11. The linear/rotary motion transforming device of claim 1, wherein at least one of the first connecting element and the second connecting element comprises a plurality of connecting elements.

12. The linear/rotary motion transforming device of claim 1, wherein a length of the first connecting element and a length of the second connecting element are different from one another.

13. The linear/rotary motion transforming device of claim 1, wherein the first connecting element is pivotally coupled to the first member and the second member by universal pivots.

14. A linear/rotary motion transforming device, comprising:
a first member disposed along an axis;
a second member linearly movable along the axis and rotatable about the axis;
a first connecting element pivotally coupled to the first member and the second member, and offset from the axis, wherein the first member and the second member are linearly and rotatably movable relative to one another;
a third member rotatable about the axis;
a second connecting element pivotally coupled to the second member and the third member, and offset from the axis, wherein the second member and the third member are linearly and rotatably movable relative to one another;
a fourth member linearly movable along the axis and rotatable about the axis; and
a third connecting element pivotally coupled to the third member and the fourth member, and offset from the axis, wherein the third member and the fourth member are linearly and rotatably movable relative to one another.

15. The linear/rotary motion transforming device of claim 14, further comprising:
a fifth member rotatable about the axis; and
a fourth connecting element pivotally coupled to the fourth member and the fifth member, and offset from the axis, wherein the fourth member and the fifth member are linearly and rotatably movable relative to one another.

16. The linear/rotary motion transforming device of claim 15, further comprising a load input mechanism operably coupled to the first member, the second member, the third member, the fourth member, or the fifth member, wherein load output is transferred via one of the other of the members.

17. The linear/rotary motion transforming device of claim 14, wherein the third member is disposed radially outboard of at least one of the first member, the second member, and the fourth member.

18. The linear/rotary motion transforming device of claim 14, wherein the second member and the fourth member move linearly in concert with one another.

19. The linear/rotary motion transforming device of claim 14, further comprising a load input mechanism operably coupled to the first member, the second member, the third member, or the fourth member, wherein load output is transferred via one of the other of the members.

20. A method for facilitating transforming of linear/rotary motion, comprising:
providing a linear/rotary motion transforming device, having
a first member disposed along an axis,
a second member linearly movable along the axis and rotatable about the axis,
a first connecting element pivotally coupled to the first member and the second member, and offset from the axis, wherein the first member and the second member are linearly and rotatably movable relative to one another,
a third member rotatable about the axis, wherein the second member is disposed along the axis between the first member and the third member, and
a second connecting element pivotally coupled to the second member and the third member, and offset from the axis, wherein the second member and the third member are linearly and rotatably movable relative to one another; and
facilitating coupling of a load input mechanism to the second member or the third member, wherein load output is transferred via the other of the second member or the third member.

21. The method of claim 20, wherein the load input mechanism is disposed proximate the first member or the third member, along the axis between the first member and the third member, or within the second member.
